(19) United States
(12) Patent Application Publication
(10) Pub. No.: US 2007/0064444 A1
(43) Pub. Date: Mar. 22, 2007

(54) Display device

(75) Inventors: Su-gun Kim, Hwaseong-gun (KR); Jae-hyun Park, Seoul (KR); Joon-chan Park, Anyang-si (KR); Kye-hoon Lee, Suwon-si (KR); Jun-young Lee, Yongin-si (KR); Jung-hyeon Kim, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/514,879

(22) Filed: Sep. 5, 2006

(30) Foreign Application Priority Data
Sep. 16, 2005 (KR) 2005-86661

(51) Int. Cl. F21V 7/04

(52) U.S. Cl. 362/612; 362/613

(57) ABSTRACT

A liquid crystal display device comprising an LCD panel, a light guiding plate disposed in back of the LCD panel and a plurality of LEDs disposed on a plane in parallel with the LCD panel along a lateral side of the light guiding plate and arranged in two rows or more is provided. With this configuration, color mixing efficiency is enhanced while size of the display device is kept to a minimum.

### CROSS-REFERENCE TO RELATED APPLICATIONS

This application claims the benefit under 35 U.S.C. § 119(a) of Korean Patent Application No. 2005-0086661, filed on Sep. 16, 2005, the entire disclosure of which is hereby incorporated by reference.

### BACKGROUND OF INVENTION

1. Field of Invention

The present invention relates to a liquid crystal display (LCD) device. More particularly, the present invention relates to an LCD device which is improved by an arrangement of light emitting diodes (LED) and color mixing efficiency.

2. Description of the Related Art

Recently, flat display devices such as an LCD, a plasma display panel (PDP) and an organic light emitting diode (OLED) have been developed as an alternative to a cathode ray tube (CRT).

The LCD device comprises an LCD panel having a thin film transistor (TFT) substrate, a color filter substrate, and a liquid crystal interposed between the substrates. The LCD panel does not emit light by itself, and thus a backlight unit is disposed in back of the TFT substrate to provide light. Transmittance of the light irradiated from the backlight unit is adjusted according to arrangement of the liquid crystals. The LCD panel and the backlight unit are accommodated in a casing.

The backlight unit may be either an edge type backlight unit or a direct type backlight unit according to a position of a light source. In the edge type backlight unit, the light source is installed on the edges of a light guiding plate. The edge type backlight unit is typically used in a small LCD device such as a monitor for a laptop computer or a monitor for a desktop computer. The edge type backlight unit has various advantages such as high uniformity of light, long lifespan and so on. Furthermore, an LCD device may be made thinner by using the edge type backlight unit.

Active development of the direct type backlight unit has corresponded to active development of large-screen LCDs. In the direct type backlight unit, a plurality of light sources are disposed under the LCD panel and directly emit light towards the entire surface of the LCD panel. The direct type backlight unit can incorporate more light sources than the edge type backlight unit. Thus, the direct type backlight unit obtains higher brightness, although the brightness is not uniform.

An LED has been employed as the light source of the edge type backlight unit, which is excellent in color reproducibility, lifespan and instantaneous lighting. The LED emits light of red, green or blue and provides white color light by mixing the light of three colors.

In such a display device, there is a need for a space in which the three colors of the LEDs are mixed. However, this required space makes it difficult to decrease the size of the LCD device.

Accordingly, there is a need for an improved backlight unit which uses less space to provide white light.

### SUMMARY OF THE INVENTION

Exemplary embodiments of the present invention address at least the above problems and/or disadvantages and provide at least the advantages described below. Accordingly, an aspect of the present invention is to provide an LCD device excellent in color mixing efficiency.

The foregoing and other objects are substantially realized by providing an LCD device including an LCD panel, a light guiding plate disposed in the back of the LCD panel, and a plurality of LEDs disposed on a plane parallel with the LCD panel along a lateral side of the light guiding plate and arranged in two rows or more.

According to an exemplary aspect of the invention, the plurality of LEDs are arranged in different rows according to the emitted colors.

According to an exemplary aspect of the invention, the LCD device further includes an LED circuit board where the plurality of LEDs are mounted and disposed in parallel with the LCD panel.

According to an exemplary aspect of the invention, the LCD device further includes a casing accommodating the light guiding plate and the LED circuit board and a radiating member provided on the outside of the casing corresponding the LED circuit board.

According to an exemplary aspect of the invention, the radiating member comprises a radiating fin.

According to an exemplary aspect of the invention, the LCD device further includes a cover partially covering the plurality of LEDs and reflecting light from the plurality of LEDs to an incident surface of the light guiding plate.

According to an exemplary aspect of the invention, the cover includes at least one dichroic reflector.

According to an exemplary aspect of the invention, three dichroic reflectors are provided to reflect different colors of light.

According to an exemplary aspect of the invention, at least one of the three dichroic reflectors are disposed between the LEDs.

According to an exemplary aspect of the invention, the LEDs emitting a corresponding colored light reflected from the dichroic reflector are disposed between the dichroic reflector and the light guiding plate.

According to an exemplary aspect of the invention, the light guiding plate has a rectangular shape, and the plurality of LEDs are arranged along a short side of the light guiding plate.

According to an exemplary aspect of the invention, the light guiding plate has a rectangular shape, and the plurality of LEDs are arranged along a long side of the light guiding plate.

The foregoing and other objects are substantially realized by providing a display device comprising a display panel, a light guide and a plurality of LEDs disposed on a plane parallel with the display panel along a lateral side or top/bottom side of the light guide and arranged as a plurality of rows.

According to an exemplary aspect of the invention, the display panel comprises an LCD panel.

According to an exemplary aspect of the invention, the display panel comprises a digital micromirror device (DMD) panel.

According to an exemplary aspect of the invention, the light guide is formed as a plate.

According to an exemplary aspect of the invention, the display device further comprises a reflector for reflecting the light emitted by the plurality of LEDs.

According to an exemplary aspect of the invention, plural reflectors are provided.

According to an exemplary aspect of the invention, the plurality of reflectors correspond in number to the number of the LEDs that emit different colors.

According to an exemplary aspect of the invention, the plurality of reflectors comprise dichroic reflectors.

According to an exemplary aspect of the invention, the different rows of the LEDs emit different colors.

According to an exemplary aspect of the invention, the LEDs within the same row emit the same color of light.

According to an exemplary aspect of the invention, the LEDs within the same row emit different colors of light.

According to an exemplary aspect of the invention, the display device further comprises a reflector for reflecting the light emitted by the plurality of LEDs.

According to an exemplary aspect of the invention, plural reflectors are provided.

According to an exemplary aspect of the invention, the plurality of reflectors correspond in number to the number of the LEDs that emit different colors.

According to an exemplary aspect of the invention, the plurality of reflectors comprise dichroic reflectors.

According to an exemplary aspect of the invention, at least one of the dichroic reflectors is disposed between the different rows of the LEDs.

According to an exemplary aspect of the invention, each of the dichroic reflectors reflects only the corresponding color and transmits other colors.

According to an exemplary aspect of the invention, the plurality of reflectors are disposed away from the rows of the LEDs such that each of the plurality of reflectors receives a plurality of colors of light emitted by the LEDs which emit different colors of light.

According to an exemplary aspect of the invention, each of the dichroic reflectors reflects only the corresponding color and transmits other colors.

According to an exemplary aspect of the invention, the LEDs within the same row emit the same colors of light.

According to an exemplary aspect of the invention, the LEDs within the same row emit different colors of light.

According to an exemplary aspect of the invention, the rows of LEDs are mounted on an LED circuit board.

According to an exemplary aspect of the invention, the LED circuit board comprises of a core which is made of aluminum.

According to an exemplary aspect of the invention, the light guiding plate is made of polyethylene terephthalate.

According to an exemplary aspect of the invention, the display device further comprises a radiating fin which is disposed to transmit the heat generated by the LEDs to the air.

Other objects, advantages, and salient features of the invention will become apparent from the detailed description, which, taken in conjunction with the annexed drawings, discloses exemplary embodiments of the invention.

### BRIEF DESCRIPTION OF THE DRAWINGS

These and other aspects, features, and advantages of certain exemplary embodiments of the present invention will be more apparent and more readily appreciated from the following detailed description, taken with reference to the accompanying drawings, in which:

FIG. 1 is an exploded perspective view of an LCD device in accordance with a first exemplary embodiment of the present invention;

FIG. 2 is a sectional view of the LCD device in accordance with the first exemplary embodiment of the present invention;

FIG. 3 is a plan view of the LCD device in accordance with the first exemplary embodiment of the present invention;

FIG. 4 is a sectional view to illustrate an optical path in the LCD device in accordance with the first exemplary embodiment of the present invention;

FIG. 5 is a plan view of an LCD device in accordance with a second exemplary embodiment of the present invention;

FIGS. 6 and 7 are sectional views of an LCD device in accordance with a third exemplary embodiment and a fourth exemplary embodiment of the present invention, respectively; and

FIG. 8 is a plan view of the LCD device in accordance with the fifth exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements thereof, are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

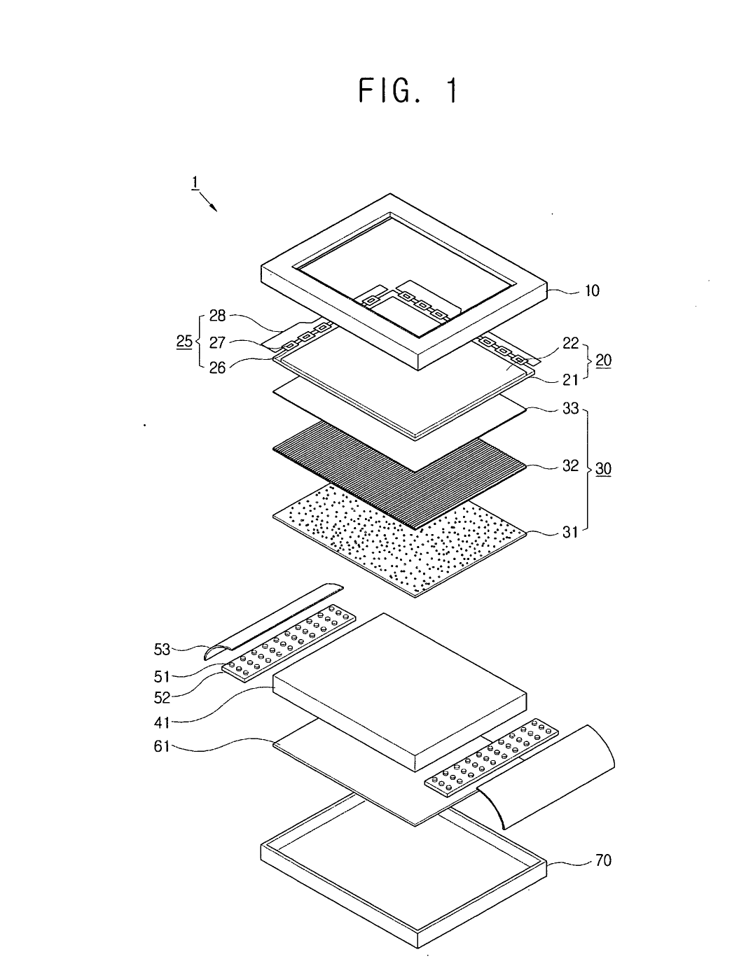

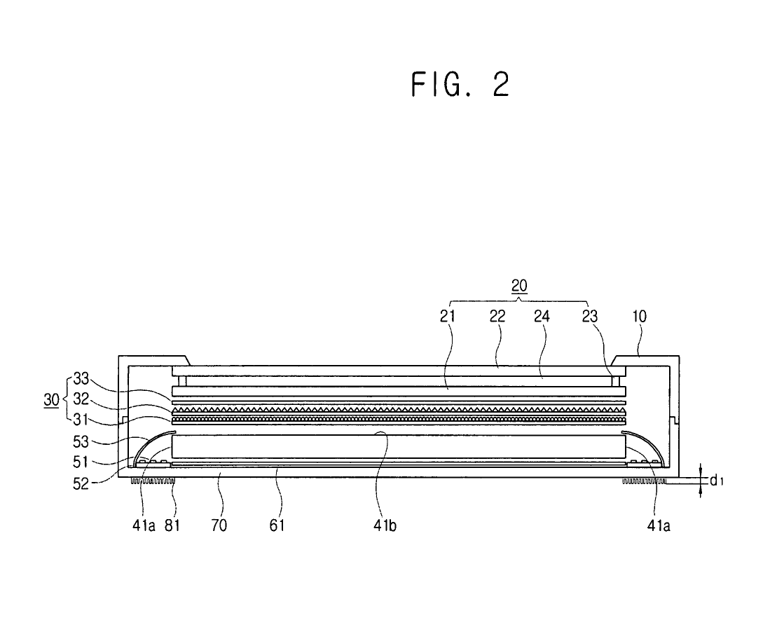

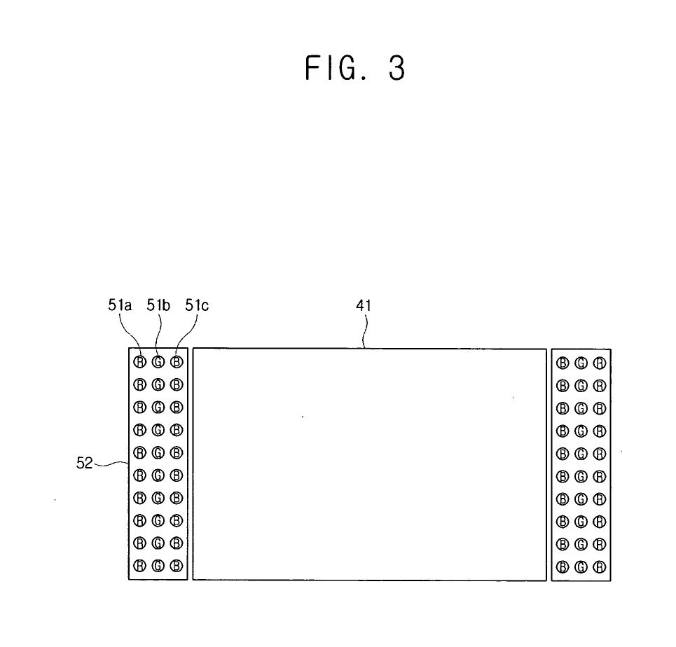

Hereinafter, an LCD device according to a first exemplary embodiment of the present invention will be described as referring to FIGS. 1 through 3.

An LCD device 1 comprises an LCD panel 20, a light control member 30, a light guiding plate 41 and LEDs 51, which are accommodated between an upper casing 10 and a lower casing 70.

The LCD panel 20 comprises a TFT substrate 21 where TFTs are formed, a color filter substrate 22 facing the TFT substrate 21, a sealant 23 adhering both substrates 21 and 22 and forming a cell gap, and a liquid crystal layer 24 surrounded with both substrates 21 and 22 and the sealant 23. The LCD panel 20 adjusts arrangement of the liquid crystal layer to thereby form an image. However, the LCD panel 20 does not emit light by itself, and thus there are provided the LEDs 51 in back of the LCD panel 20 to provide light to the LCD panel 20. A driving part 25 may be provided in one side of the TFT substrate 21 to apply a driving signal. The driving part 25 comprises a flexible printed circuit (FPC) 26, a driving chip 27 mounted on the FPC 26, and a printed circuit board (PCB) 28 connected to one side of the FPC 26. The driving part 25 shown in FIG. 1 may be formed in a chip on film (COF) type. However, any well-known type, such as a tape carrier package (TCP) type, a chip on glass (COG) type or the like, is available as the driving part. Also, the driving part 25 may be formed on the TFT substrate 21 while lines are assembled.

The light control member 30 may be disposed in back of the LCD panel 20 and comprises a diffusion film 31, a prism film 32 and a protection film 33.

The diffusion film 31 comprises a base plate and a coating layer having beads formed on the base plate. The diffusion film 31 diffuses light provided through the light guiding plate 41, thereby improving brightness uniformity.

The prism film 32 comprises triangular prisms formed in an alignment thereon. The prism film 32 concentrates the light diffused in the diffusion film 31 perpendicularly to a surface of the LCD panel 20. Alternatively, two prism films 32 may be used and micro prisms formed on each of the prism films 32 make an angle with each other. The light passing through the prism films 32 mostly travels perpendicularly, thereby forming a uniform brightness distribution. If necessary, a reflective polarizing film may be used along with the prism films 32, or only the reflective polarizing film may be used without the prism films 32.

The protection film 33 may be disposed at the top of the light control member 30 to protect the prism films 32, which are vulnerable to scratching.

The light guiding plate 41 may be disposed under the diffusion film 31. The light guiding plate 41 is plate-type and provides light from the LEDs 51, as a point light source, to the diffusion film 31 as a surface light. The light guiding plate 41 may comprise polymethyl methacrylate (PMMA) of an acryl type. The light guiding plate 41 comprises a pair of surfaces 41a where light is incident and an exit surface 41b, facing the diffusion film 31, and where light exits.

The LEDs 51 may be disposed on sides of either or both incident surfaces 41a of the light guiding plate 41. Also, the LEDs 51 may be disposed in three rows parallel to each incident surface 41a.

The LEDs 51 may be mounted on an LED circuit board 52 in three rows and disposed beside opposite incident surfaces 41a. The LED circuit board 52 may be disposed in parallel with the exit surface 41b.

The LED circuit board 52 comprises a core which may be made of aluminum having excellent thermal conductivity.

The LEDs 51 comprise a red LED 51a, a green LED 51b and a blue LED 51c, each having a corresponding colored light. The colored lights output from the LEDs are mixed so as to be incident as white light on the light guiding plate 41.

In the exemplary embodiment, the red LEDs 51a may be disposed in a row farthest from the light guiding plate 41. The green LEDs 51b may be disposed in a row between the red LED 51a and the light guiding plate 41 and the blue LEDs 51c may be disposed in a row between the green LED 51b and the light guiding plate 41. In other words, the LEDs 51 may be disposed in rows different according to emitting colors. In another exemplary embodiment, the LEDs 51 may be disposed in four rows or more.

The LEDs 51 are covered with a cover 53. The cover 53 reflects the light from the LEDs 51 in a direction of the incident surfaces 41a of the light guiding plate 41. The cover 53 may comprise an aluminum plate which is excellent in reflectance and may be coated with silver on a surface facing the LEDs 51. Alternatively, the cover 53 may comprise any material or coating suitable for the desired reflection of light emitted from the LEDs.

A reflecting plate 61 is disposed under the light guiding plate 41. The reflecting plate 61 reflects light which is incident on the bottom of the light guiding plate 41 so as to cause it to proceed to the exit surface 41b. The reflecting plate 61 may be made of polyethylene terephthalate (PET) or polycarbonate (PC), or coated with silver or aluminum. Alternatively, the reflecting plate 61 may comprise any material or coating suitable for the desired reflection of light incident on the bottom of the light guiding plate 41.

A radiating fin 81 may be provided on an external surface of the lower casing 70 corresponding to the LEDs 51. There is a large amount of heat generated in the LEDs 51 when the LCD device is driven. If the heat is not properly radiated, it causes the lifespan and the brightness of the LEDs 51 to decrease and the LCD panel 20 and the light control member 30 to be deteriorated. The heat generated in the LEDs 51 passes through the LED circuit board 52 and the lower casing 70 and is transmitted to the radiating fin 81. The radiating fin 81 has a wide surface area, thereby radiating heat by contacting with air outside. The LED circuit board 52 in the exemplary embodiment contacts with the lower casing 70, thereby efficiently transmitting the heat, and accordingly the thickness d1 of the radiating fin 81 may be reduced. Thus, the LCD device 1 decreases in the size. Unlike the exemplary embodiment, the LED circuit board 52 may contact with the radiating fin 81 directly, or a gap pad may be disposed between the LED circuit board 52 and the radiating fin 81. Further, a cooling pipe or a cooling fan may be provided as a radiating member besides the radiating fin 81.

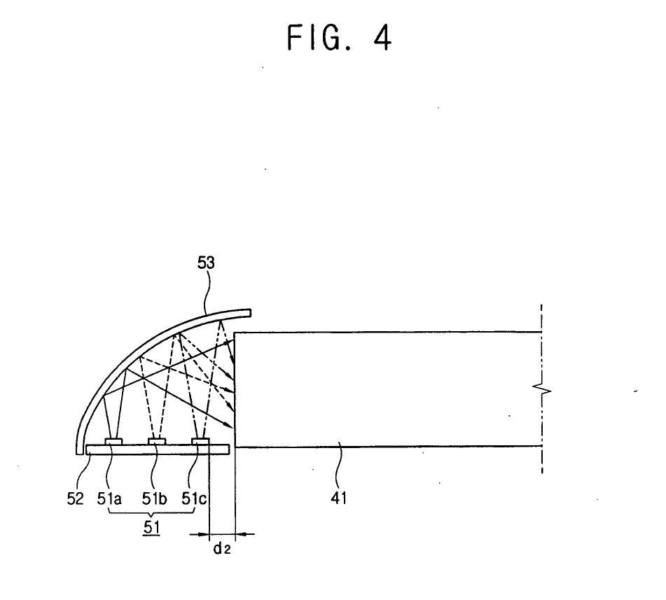

FIG. 4 is a sectional view to illustrate an optical path in the LCD device according to the first exemplary embodiment of the present invention.

As shown in FIG. 4, the angle of reflection of the light reflected on the cover 53 varies according to the distance between the LEDs 51 and the light guiding plate 41, because the LEDs 51 are disposed in a plurality of rows on a plane parallel with the exit surface 41b. Thus, an optical path of the light generated in the LEDs 51 varies, thereby increasing color mixing efficiency. Accordingly, a distance d2 between the incident surfaces 41a of the light guiding plate 41 and the LEDs 51 is decreased, thereby decreasing the size of the LCD device 1.

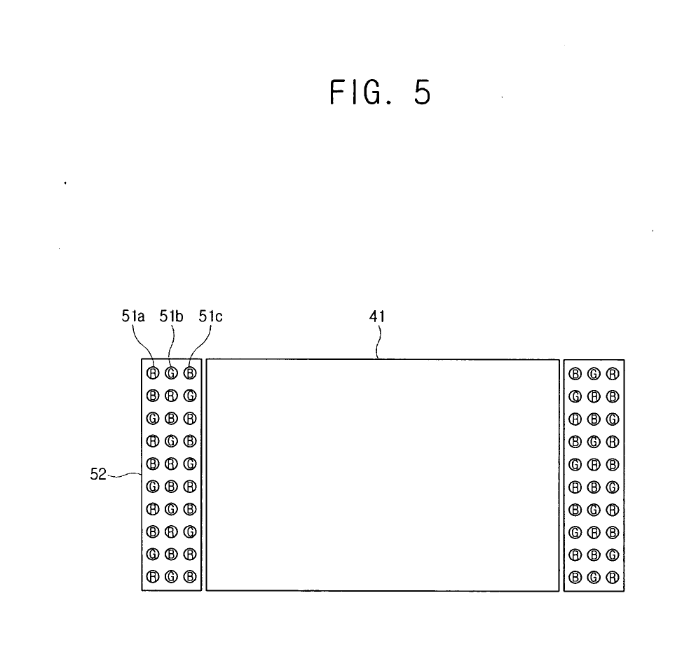

FIG. 5 is a plan view of a main part of an LCD device according to a second exemplary embodiment of the present invention.

LEDs 51 are disposed on opposite sides of a light guiding plate 41. The LEDs 51 may be disposed in three rows, and each of the rows comprises a red LED 51a, a green LED 5 1b and a blue LED 51c. As shown in the FIG. 5, the positions of the LEDs emitting the same color may be mixed or alternated. Alternatively, the positions of the LEDs may be mixed or alternated in a random pattern.

This configuration makes an optical path of light of each color vary, thereby increasing color mixing efficiency.

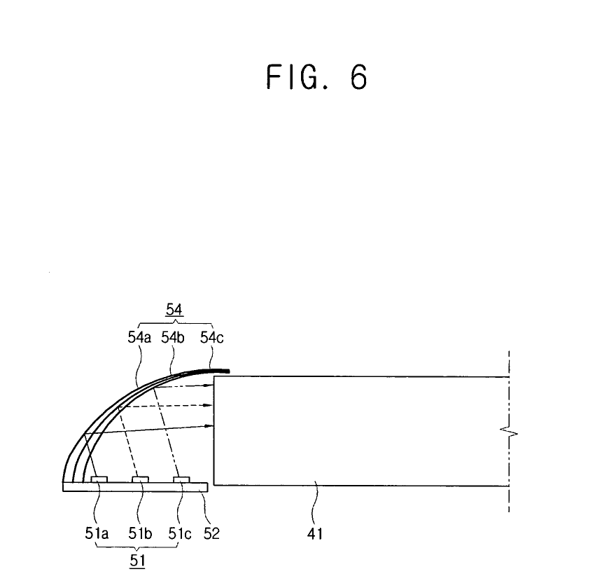

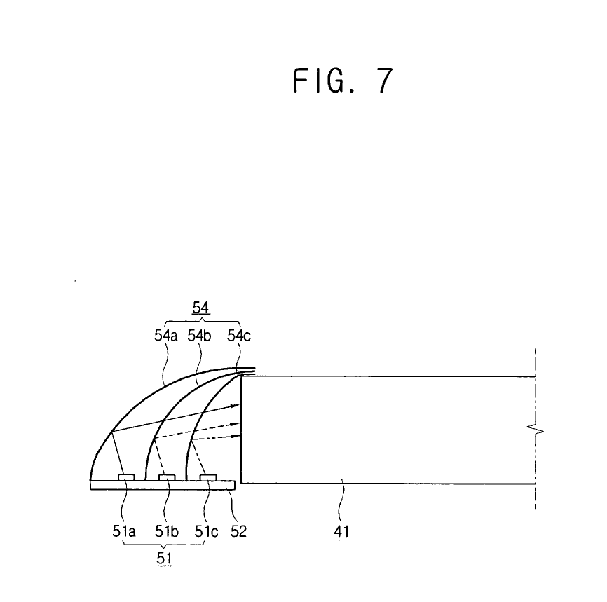

FIGS. 6 and 7 are sectional views of an LCD device according to a third exemplary embodiment and a fourth exemplary embodiment of the present invention.

In the third exemplary embodiment shown in FIG. 6, a cover 54 comprises a first dichroic reflector 54a reflecting a red color, a second dichroic reflector 54b reflecting a green color and a third dichroic reflector 54c reflecting a blue color. LEDs 51 are arranged in three rows but may be arranged to have additional rows to accommodate additional LEDs emitting additional colors.

One end portion of the cover 54 is disposed to a side of the LEDs 51 and the other end portion thereof is extended toward an exit surface 41b of a light guiding plate 41.

In the third exemplary embodiment, an optical path varies according to the emitted color of light as well as positions of the LEDs 51. Thus, color mixing efficiency is excellent. It is noted that in the third exemplary embodiment, the rows of LEDs may be implemented in accordance with the LED structure as shown in the first exemplary embodiment or second exemplary embodiment. That is, each row of LEDs may be emitting the same color or different colors (mixed).

In a fourth exemplary embodiment shown in FIG. 7, a cover 54 comprises a first dichroic reflector 54a reflecting a red color, a second dichroic reflector 54b reflecting a green color and a third dichroic reflector 54c reflecting a blue color. LEDs 51 may be arranged in three rows and the LEDs 51 emitting the same color are disposed in the same row like the first exemplary embodiment. In the fourth exemplary embodiment, a blue LED 51c, a green LED 51b and a red LED 51a are sequentially disposed from a light guiding plate 41. Similar to the third exemplary embodiment, LEDs 51 are arranged in three rows but may be arranged to have additional rows to accommodate additional LEDs emitting additional colors.

One end portion of the first dichroic reflector 54a is disposed to a side of the red LED 5 1a and the other portion thereof is extended toward an exit surface 41b of the light guiding plate 41. One end portion of the second dichroic reflector 54b is disposed between a side of the red LED 51a and the green LED 51b and the other portion thereof is extended toward the exit surface 41b of the light guiding plate 41. One end portion of the third dichroic reflector 54c is disposed between a side of the green LED 51b and the blue LED 51c and the other portion thereof is extended toward the exit surface 41b of the light guiding plate 41.

With this configuration, light from the red LED 51a is reflected on the first dichroic reflector 54a, light from the green LED 51b is reflected on the second dichroic 54b, and light from the blue LED 51c is reflected on the third dichroic 54c.

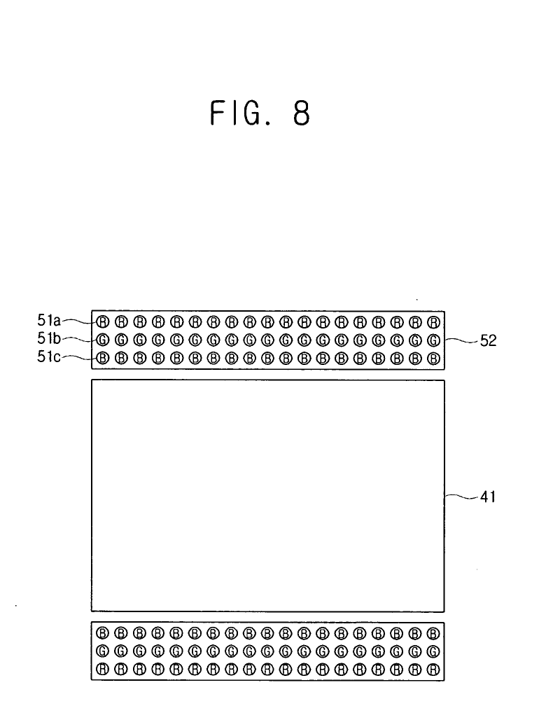

In the fifth embodiment show in FIG. 8, the LEDs 51 are disposed along long sides of the light guiding plate 41.

The light guiding plate 41 has a rectangular shape from a plan view. Thus, the light guiding plate 41 has a pair of short sides and a pair of long sides. The LEDs 51 are disposed along short sides of the light guiding plate 41 in previous exemplary embodiment.

Furthermore, the previous exemplary embodiments may be also applied to the fifth exemplary embodiment.

The present invention may be applicable to digital light processing (DLP) projection systems utilizing DMD as the display panel or LCD projection systems and any other display systems that may utilize LED arrays as the light source.

The present invention may be applicable to LED arrays having two rows, in other words mixing of two colors, to implement the white light source.

While the invention has been shown and described with reference to certain exemplary embodiments thereof, it will be understood by those skilled in the art that various changes in form and details may be made therein without departing from the spirit and scope of the invention as defined by the appended claims and the full scope of equivalents thereof.

What is claimed is:

1. A liquid crystal display (LCD) device, comprising:
an LCD panel;
a light guiding plate disposed in back of the LCD panel; and
a plurality of light emitting diodes (LEDs) disposed on a plane substantially parallel with a surface of the LCD panel along a side of the light guiding plate and arranged in two or more rows.

2. The liquid crystal display device according to claim 1, wherein the two or more rows are arranged according to a color of light emitted by the LEDs in each row.

3. The liquid crystal display device according to claim 1, further comprising an LED circuit board wherein the plurality of LEDs are mounted on the LED circuit board and disposed in parallel with the LCD panel.

4. The liquid crystal display device according to claim 3, further comprising:
a casing accommodating the light guiding plate and the LED circuit board; and
a radiating member provided on the outside of the casing corresponding to the LED circuit board.

5. The liquid crystal display device according to claim 4, wherein the radiating member comprises a radiating fin.

6. The liquid crystal display device according to claim 1, further comprising at least one cover at least partially covering the plurality of LEDs and reflecting light from the plurality of LEDs to an incident surface of the light guiding plate.

7. The liquid crystal display device according to claim 6, wherein the at least one cover comprises at least one dichroic reflector.

8. The liquid crystal display device according to claim 7, wherein the at least one dichroic reflector comprises three dichroic reflectors and wherein each dichroic reflector reflects a different color of light.

9. The liquid crystal display device according to claim 8, wherein at least one of the three dichroic reflectors is disposed between the LEDs.

10. The liquid crystal display device according to claim 9, wherein LEDs emitting light of a color corresponding to the color of light reflected from one of the dichroic reflectors are disposed between the one of the dichroic reflectors and the light guiding plate.

11. The liquid crystal display device according to claim 6, wherein the at least one cover reflects light from each of the two or more rows of LEDs along unequal optical paths to the incident surface of the light guiding plate.

12. The liquid crystal display device according to claim 11, wherein the at least one cover extends from a side of one of the two or more rows of LEDs toward a light exit surface of the light guiding plate.

13. The liquid crystal display device according to claim 1, wherein the light guiding plate has a rectangular shape, and the two or more rows are arranged along a short side of the light guiding plate.

14. The liquid crystal display device according to claim 1, wherein the light guiding plate has a rectangular shape, and the two or more rows are arranged along a long side of the light guiding plate.

15. A display device comprising:
a display panel;
a light guide; and
a plurality of light emitting diodes (LEDs) disposed on a plane parallel with the display panel along a side of the light guide and arranged as a plurality of rows.

16. The display device according to claim 15, wherein the display panel comprises a liquid crystal display (LCD) panel.

17. The display device according to claim 15, wherein the display panel comprises a digital micromirror device (DMD) panel.

18. The display device according to claim 16, wherein the light guide comprises a plate.

19. The display device according to claim 18, further comprising at least one reflector for reflecting light emitted by the plurality of LEDs.

20. The display device according to claim 19, wherein the at least one reflector comprises a plurality of reflectors.

21. The display device according to claim 20, wherein the number of reflectors corresponds to the number of different colors emitted by the LEDs.

22. The display device according to claim 21, wherein the plurality of reflectors comprise dichroic reflectors.

23. The display device according to claim 18, wherein each of the plurality of rows of LEDs emits a color of light different from the remaining rows.

24. The display device according to claim 23, wherein the LEDs within a same row emit the same color of light.

25. The display device according to claim 23, wherein the LEDs within a same row emit different colors of light.

26. The display device according to claim 23, further comprising at least one reflector for reflecting the light emitted by the plurality of LEDs.

27. The display device according to claim 26, wherein the at least one reflector comprises a plurality of reflectors.

28. The display device according to claim 27, wherein the number of reflectors corresponds to the number of different colors emitted by the LEDs.

29. The display device according to claim 28, wherein each of the plurality of reflectors reflects light from the two or more rows of LEDs along unequal optical paths to an incident surface of the light guiding plate.

30. The display device according to claim 27, wherein the plurality of reflectors comprise dichroic reflectors.

31. The display device according to claim 30, wherein at least one of the dichroic reflectors is disposed between the different rows of the LEDs.

32. The display device according to claim 31, wherein each of the dichroic reflectors reflects only the corresponding color and transmits other colors.

33. The display device according the claim 30, wherein each of the plurality of reflectors is disposed such that each of the plurality of reflectors receives a plurality of colors of light emitted by the LEDs which emit different colors of light.

34. The display device according to the claim 33, wherein each of the dichroic reflectors reflects only the corresponding color and transmits other colors.

35. The display device according to claim 34, wherein each of the plurality of reflectors reflects light from the two or more rows of LEDs along unequal optical paths to an incident surface of the light guiding plate.

36. The display device according to the claim 34, wherein the LEDs within a same row emit the same colors of light.

37. The display device according to the claim 34, wherein the LEDs within a same row emit different colors of light.

38. The display device according to the claim 37, wherein the rows of LEDs are mounted on an LED circuit board.

39. The display device according to claim 38, wherein the LED circuit board comprises of a core which is made of aluminum.

40. The display device according to claim 39, wherein the light guiding plate is made of polyethylene terephthalate.

41. The display device according to claim 39, further comprising a radiating fin for transmitting heat generated by the LEDs.
